(19) United States
(12) Patent Application Publication
(10) Pub. No.: US 2024/0172161 A1
(43) Pub. Date: May 23, 2024

(54) COMMUNICATION MANAGEMENT SERVER, CONTROL APPARATUS, AND COMMUNICATION MANAGEMENT METHOD

(71) Applicant: NEC Corporation, Minato-ku, Tokyo (JP)

(72) Inventor: Yoshihiko Hoshino, Tokyo (JP)

(73) Assignee: NEC Corporation, Minato-ku, Tokyo (JP)

(21) Appl. No.: 18/283,390

(22) PCT Filed: Mar. 26, 2021
(86) PCT No.: PCT/JP2021/012934

§ 371 Date: Sep. 21, 2023

(51) Int. Cl. H04W 60/04; H04W 48/18; H04W 64/00

(52) U.S. Cl. CPC H04W 60/04; H04W 48/18; H04W 64/006

(57) ABSTRACT

A communication management server according to one example embodiment of the present disclosure includes: at least one memory storing instructions; and at least one processor configured to execute the instructions to: receive first connection destination information being information about a first connection destination to which user equipment requests connection, and position information of the user equipment, from a control apparatus configured to control connection of the user equipment; acquire second connection destination information being information about a connection destination of the user equipment associated with the position information; determine whether the second connection destination information is different from the first connection destination information; and transmit the second connection destination information to the control apparatus in a case where the second connection destination information is different from the first connection destination information.

### TECHNICAL FIELD

The present invention relates to a communication system, a communication management server, a control apparatus, a communication management method, a communication control method, and a non-transitory computer-readable medium.

### BACKGROUND ART

Various communication systems including user equipment (UE) are disclosed. For example, Patent Literature 1 discloses a communication system in which after user equipment sends a TAU/RAU Request to a radio access network node, the radio access network node selects a core network node based on information corresponding to the usage type of the user equipment.

Also, Patent Literature 2 discloses a communication system in which, where the IP address of the user equipment is an ID and the MAC address of the group-closed network gateway is a Locator, routing control is performed by separating the ID/Locator in the group-closed network.

### CITATION LIST

### Patent Literature

[Patent Literature 1] Japanese Unexamined Patent Application Publication No. 2018-137765
[Patent Literature 2] Japanese Unexamined Patent Application Publication No. 2018-032935

### SUMMARY OF INVENTION

### Technical Problem

In 5G (5th Generation) or 4G (4th Generation) mobile services, it is beneficial for users and mobile communication operators (communication carriers) to be able to connect user equipment to various communication services. However, to do so, it is necessary to change the DNN (Data Network Name) or APN (Access Point Name) of the user equipment. Although it is possible to specify the DNN/APN to be connected by having the user operate the user equipment, there is a problem in that the operation is troublesome for the user.

In view of the problems described above, it is an object of the present disclosure to provide a communication system, a communication management server, a control apparatus, a communication management method, a communication control method and a non-transitory computer-readable medium capable of reducing the trouble of user's operations with user equipment when the user equipment is connected to the network.

### Solution to Problem

A communication system according to an aspect of the present example embodiment includes a control apparatus configured to control connection of user equipment and a communication management server connected to the control apparatus. In response to receiving a connection request from the user equipment to a first connection destination, the control apparatus transmits position information of the user equipment to the communication management server. The communication management server acquires second connection destination information indicating a second connection destination of the user equipment associated with the position information, and transmits the acquired second connection destination information to the control apparatus. The control apparatus sets the second connection destination indicated by the second connection destination information as a connection destination of the user equipment with precedence over the first connection destination, and controls the user equipment in such a way as to connect to the connection destination.

A communication management server according to an aspect of the present example embodiment includes a receiving means for receiving first connection destination information being information about a first connection destination to which user equipment requests connection, and position information of the user equipment, from a control apparatus configured to control connection of the user equipment, a determining means for acquiring second connection destination information being information about a connection destination of the user equipment associated with the position information, and determining whether the second connection destination information is different from the first connection destination information, and a transmitting means for transmitting the second connection destination information to the control apparatus in a case where the second connection destination information is different from the first connection destination information.

A control apparatus according to an aspect of the present example embodiment includes a receiving unit configured to receive a connection request from user equipment to a first connection destination, a transmitting unit configured to, in response to the connection request, transmit position information of the user equipment to a communication management server, and a connection control unit configured to set a second connection destination indicated by second connection destination information received from the communication management server as a connection destination of the user equipment with precedence over the first connection destination, and control the user equipment in such a way as to connect to the connection destination.

A communication management method according to an aspect of the present example embodiment is executed by a communication system, and includes transmitting, by a control apparatus controlling connection of user equipment, in response to receiving a connection request from the user equipment to a first connection destination, position information of the user equipment to a communication management server, acquiring, by the communication management server, second connection destination information indicating a second connection destination of the user equipment associated with the position information, and transmitting the acquired second connection destination information to the control apparatus, and setting, by the control apparatus, the second connection destination indicated by the second connection destination information as a connection destination of the user equipment with precedence over the first connection destination, and controlling the user equipment in such a way as to connect to the connection destination.

A communication management method according to another aspect of the present example embodiment is executed by a communication management server, and includes receiving first connection destination information being information about a first connection destination to which user equipment requests connection, and position information of the user equipment, from a control apparatus configured to control connection of the user equipment, acquiring second connection destination information being information about a connection destination of the user equipment associated with the position information, and determining whether the second connection destination information is different from the first connection destination information, and transmitting the second connection destination information to the control apparatus in a case where the second connection destination information is different from the first connection destination information.

A communication control method according to an aspect of the present example embodiment is executed by a control apparatus, and includes receiving a connection request from user equipment to a first connection destination, in response to the connection request, transmitting position information of the user equipment to a communication management server, and setting a second connection destination indicated by second connection destination information received from the communication management server as a connection destination of the user equipment with precedence over the first connection destination, and controlling the user equipment in such a way as to connect to the connection destination.

A non-transitory computer-readable medium according to an aspect of the present example embodiment stores a program that causes a computer to execute receiving first connection destination information being information about a first connection destination to which user equipment requests connection, and position information of the user equipment, from a control apparatus configured to control connection of the user equipment, acquiring second connection destination information being information about a connection destination of the user equipment associated with the position information, and determining whether the second connection destination information is different from the first connection destination information, and transmitting the second connection destination information to the control apparatus in a case where the second connection destination information is different from the first connection destination information.

A non-transitory computer-readable medium according to another aspect of the present example embodiment stores a program that causes a computer to execute receiving a connection request from user equipment to a first connection destination, in response to the connection request, transmitting position information of the user equipment to a communication management server, and setting a second connection destination indicated by second connection destination information received from the communication management server as a connection destination of the user equipment with precedence over the first connection destination, and controlling the user equipment in such a way as to connect to the connection destination.

### Advantageous Effects of Invention

According to the present disclosure, a communication system, a communication management server, a control apparatus, a communication management method, a communication control method, and a non-transitory computer-readable medium capable of reducing the trouble of user's operations with user equipment when the user equipment is connected to the network can be provided.

### BRIEF DESCRIPTION OF DRAWINGS

FIG. 1 is a schematic diagram illustrating an example of a communication system according to a first example embodiment;

FIG. 2 is a block diagram illustrating an example of a control apparatus according to the first example embodiment;

FIG. 3 is a block diagram illustrating an example of a communication management server according to the first example embodiment;

FIG. 4 is a flowchart illustrating an example of processing of the control apparatus according to the first example embodiment;

FIG. 5 is a flowchart illustrating an example of processing of the communication management server according to the first example embodiment;

FIG. 6 is a schematic diagram illustrating an example of a 5G communication system according to a second example embodiment;

FIG. 7 is a sequence diagram illustrating an example of processing of the 5G communication system according to the second example embodiment;

FIG. 8 is a schematic diagram illustrating an example of a 5G communication system according to related art;

FIG. 9 is a schematic diagram illustrating an example of an application situation of the 5G communication system according to the second example embodiment;

FIG. 10 is a schematic diagram illustrating an example of a 4G communication system according to the second example embodiment;

FIG. 11 is a sequence diagram illustrating an example of processing of the 4G communication system according to the second example embodiment;

FIG. 12 is a schematic diagram illustrating an example of a 4G communication system according to related art; and

FIG. 13 is a block diagram illustrating an example of a hardware configuration of the apparatus according to each embodiment.

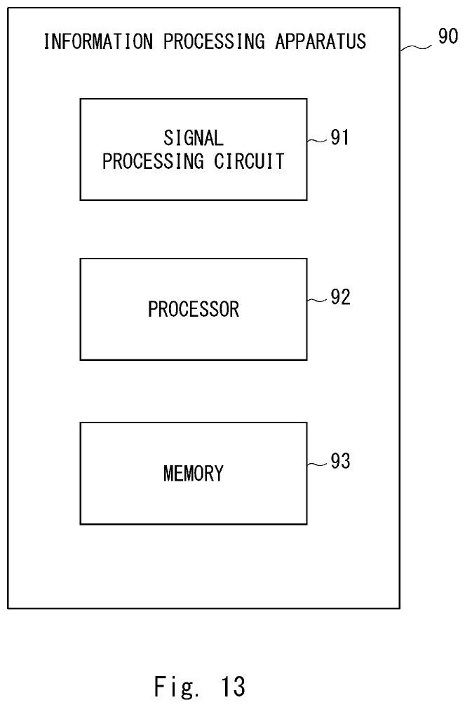

### FIRST EXAMPLE EMBODIMENT

A first example embodiment of the present disclosure will be described below with reference to the drawings.

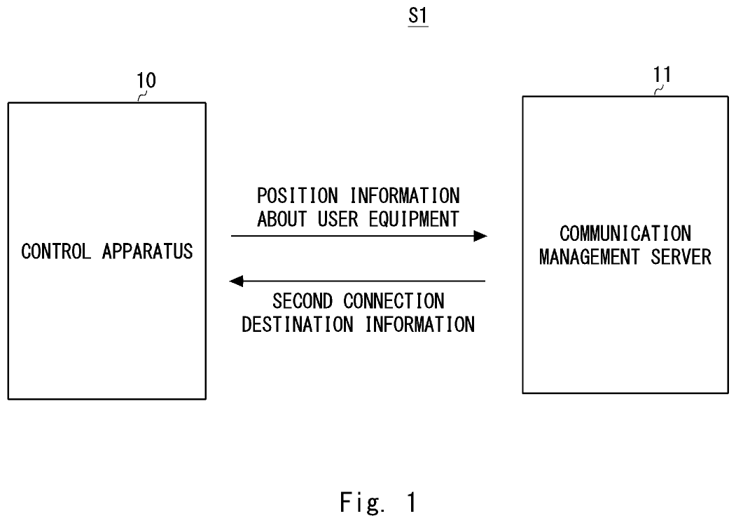

FIG. 1 is a schematic diagram illustrating an example of a communication system. The communication system S1 includes a control apparatus 10 and a communication management server 11. The control apparatus 10 belongs to, for example, a core network (or a backbone network), and controls connection of user equipment to various networks. The communication management server 11 is connected to the control apparatus 10, and manages communication of the user equipment. The control apparatus 10 and the communication management server 11 are controlled by a control unit (controller) inside each apparatus.

In FIG. 1, in response to receiving a connection request from the user equipment to the first connection destination, the control apparatus 10 transmits the position information of the user equipment to the communication management server 11. This process may, for example, be performed by the control apparatus together with the inquiry of the subscriber information of the user equipment. The communication management server 11 acquires second connection destination information indicating a second connection destination of the user equipment associated with the position information received from the control apparatus 10, and transmits the acquired the second connection destination information to the control apparatus 10. An example of the connection destination information is information such as an access point and a data network as the connection destination, but is not limited thereto.

The control apparatus 10 sets the second connection destination indicated by the second connection destination information as the connection destination of the user equipment with precedence over the first connection destination. Then, the control apparatus 10 controls the user equipment to connect to the connection destination. The details of each apparatus are explained below.

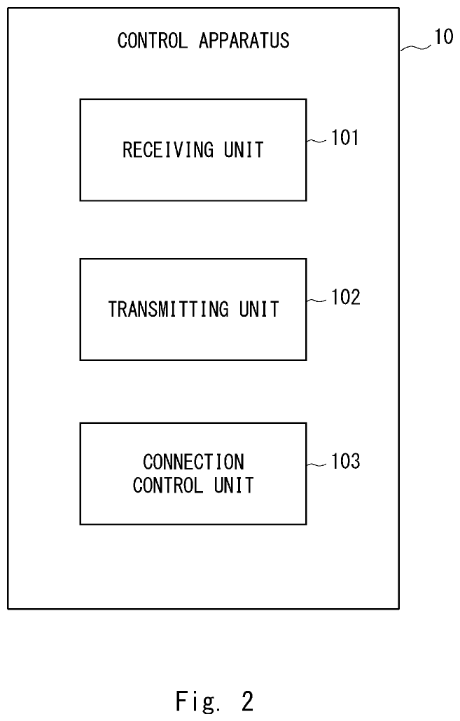

FIG. 2 is a block diagram illustrating a configuration example of the control apparatus 10. The control apparatus 10 includes a receiving unit 101, a transmitting unit 102, and a connection control unit 103. Hereinafter, each constituent element is explained.

The receiving unit 101 receives the connection request from the user equipment to the first connection destination. For example, when the user equipment accesses the core network and requests a connection to another network, the receiving unit 101 receives this connection request. The transmitting unit 102 transmits the position information of the user equipment to the communication management server 11 in response to the connection request received by the receiving unit 101. The receiving unit 101 and the transmitting unit 102 may be configured, for example, as a transmitting-and-receiving unit (transceiver).

The connection control unit 103 sets the second connection destination indicated by the second connection destination information received from the communication management server 11 as the connection destination of the user equipment with precedence over the first connection destination. The “precedence” means that one connection destination selected as the connection destination of the user equipment is set as the second connection destination associated with the position information. However, if connection cannot be made to the second connection destination, the connection control unit 103 may set, as the first connection destination, one connection destination selected as the connection destination of the user equipment. Then, the connection control unit 103 controls the user equipment to connect to the set connection destination. This allows the user equipment to connect to the preferred connection destination.

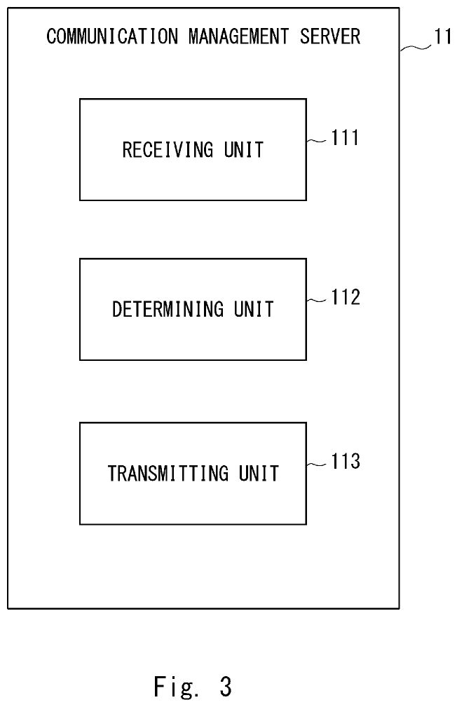

FIG. 3 is a block diagram illustrating a configuration example of a communication management server 11. The communication management server 11 includes a receiving unit 111, a determining unit 112, and a transmitting unit 113. Hereinafter, each constituent element is explained.

The receiving unit 111 receives, from the control apparatus 10, first connection destination information, which is information about a first connection destination to which user equipment requests a connection, and the position information of the user equipment. For example, as described above, when the user equipment accesses the core network and requests a connection to another network, the control apparatus 10 transmits the first connection destination information and the position information of the user equipment to the communication management server 11.

The determining unit 112 acquires second connection destination information, which is information on the connection destination of user equipment associated with the position information received by the receiving unit 111. Then, the determining unit 112 determines whether the second connection destination information is different from the first connection destination information.

The transmitting unit 113 transmits the second connection destination information to the control apparatus 10 in a case where the second connection destination information is different from the first connection destination information. In a case where the determining unit 112 determines that the second connection destination information is the same as the first connection destination information, the transmitting unit 113 may transmit a response signal without the second connection destination information to the control apparatus 10, or may transmit a response signal including the second connection destination information to the control apparatus 10. The receiving unit 111 and the transmitting unit 113 may be configured, for example, as a transmitting-and-receiving unit (transceiver).

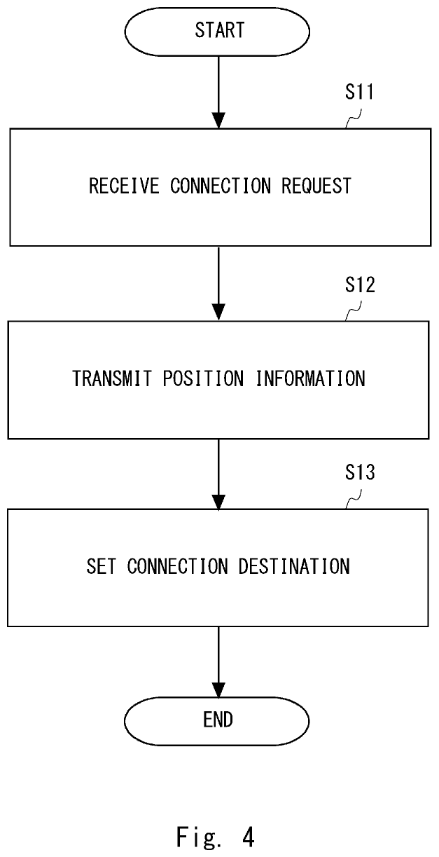

FIG. 4 is a flowchart illustrating an example of typical processing of the control apparatus 10. This flowchart explains the processing of the control apparatus 10. First, the receiving unit 101 of the control apparatus 10 receives a connection request from the user equipment to the first connection destination (step S11; receiving step). The transmitting unit 102 transmits the position information of the user equipment to the communication management server 11 in response to the connection request (step S12; transmitting step).

The connection control unit 103 sets the second connection destination indicated by the second connection destination information received from the communication management server 11 as the connection destination of the user equipment with precedence over the first connection destination. Then, the connection control unit 103 controls the user equipment to connect to the connection destination (step S13; connection control step).

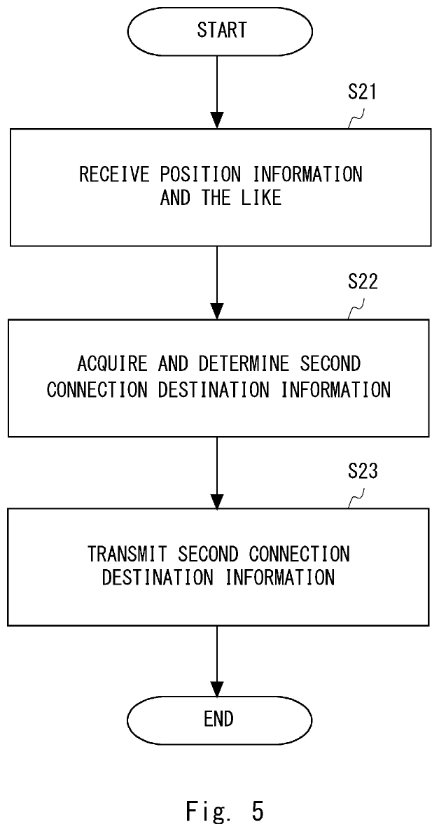

FIG. 5 is a flowchart illustrating an example of typical processing of the communication management server 11, and this flowchart explains the processing of the communication management server 11. First, the receiving unit 111 receives from the control apparatus 10 controlling connection of the user equipment, the first connection destination information, which is information about a first connection destination to which user equipment requests a connection, and the position information of the user equipment (step S21; receiving step). The determining unit 112 acquires the second connection destination information which is information about the connection destination of the user equipment associated with the position information of the user equipment, and determines whether the second connection destination information is different from the first connection destination information (step S22; determining step). The transmitting unit 113 transmits the second connection destination information to the control apparatus 10 in a case where the second connection destination information is different from the first connection destination information (step S23; transmitting step).

The control apparatus 10 and the communication management server 11 can perform the above processing for each user equipment. As a result, when the user equipment connects to the network, the control apparatus 10 can set the connection destination information based on the position information of the user equipment, and therefore, the user of the user equipment does not have to change the connection destination information. Therefore, the trouble of user's operations with user equipment can be reduced.

### SECOND EXAMPLE EMBODIMENT

Hereinafter, an embodiment of the present invention will be described with reference to the drawings. The second example embodiment illustrates an example of an application of the first example embodiment in each of the 5G and 4G communication standards.

(5G)

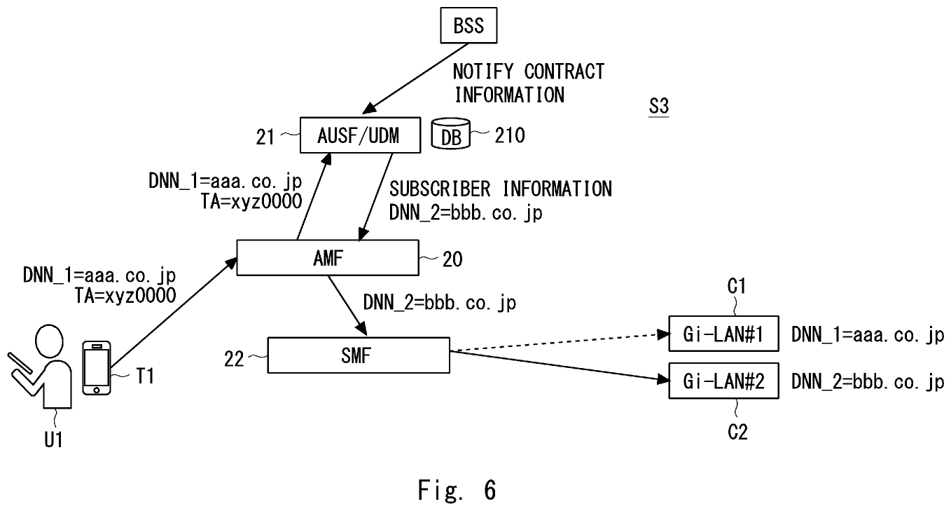

FIG. 6 is a schematic diagram illustrating an example of a 5G communication system. A communication system S3 includes, as main constituent elements, an AMF (Access and Mobility Management Function) 20, an AUSF (AUthentication Server Function)/UDM (Unified Data Management) 21, and an SMF (Session Management Function) 22. The AMF 20, the AUSF/UDM 21, and the SMF 22 are nodes which belong to the C-plane function side. Hereinafter, processing of each apparatus will be explained.

The AMF 20 corresponds to the control apparatus 10 according to the first example embodiment, and controls connection to various networks of user equipment T1. Specifically, the AMF 20 performs subscriber authentication/security, position management of user equipment, and the like.

As illustrated in FIG. 2, the AMF 20 includes a receiving unit 101, a transmitting unit 102, and a connection control unit 103. The receiving unit 101 receives, from the user equipment T1 possessed by a user U1, a connection request to the network. This connection request includes at least a DNN_1 (aaa.co.jp; first connection destination information) which is the connection destination information of the user equipment T1 and a TA (Tracking Area) which is information about the position registration area of the base station accommodating the user equipment T1. In this example, the TA is “xyz0000”, and indicates the position information of the user equipment. Furthermore, the connection request includes identification information of the user equipment T1. In response to the connection request, the transmitting unit 102 transmits an inquiry of subscriber information of the user equipment T1 to the AUSF/UDM 21, and transmits the identification information of the user equipment T1, the DNN_1 and the TA to the AUSF/UDM 21. In this manner, the AMF 20 authenticates whether a SIM card possessed by the user equipment T1 is connectable. The details of processing of the connection control unit 103 are explained later.

The AUSF/UDM 21 corresponds to the communication management server 11 according to the first example embodiment, connects to the AMF 20, and manages communication of the user equipment. Here, the AUSF and the UDM are separate nodes, but they work together. The UDM has a DB 210 as a repository that holds and manages subscriber information, and the AUSF executes processing based on subscriber information held in the DB 210. Also, the AUSF/UDM 21 acquires subscriber information for each subscriber from a BSS (Business Support System) and stores the subscriber information into the DB 210. The BSS is a management system of subscriber information possessed by a communication carrier. For example, when the subscriber of the user equipment subscribes to the communication carrier, the contract information is notified to the AUSF/UDM 21. The AUSF/UDM 21 holds this contract information in the DB 210 as subscriber information.

The subscriber information related to each piece of user equipment held in the DB 210 includes the identification information of the user equipment and a data network of the connection destination corresponding to the position of the user equipment, which are associated with each other. In this example, the DB 210 holds the following subscriber information with respect to the user equipment T1.
TA is other than “xyz0000”: DNN_1 (aaa.co.jp)
TA is “xyz0000”: DNN_2 (bbb.co.jp) . . . (1)

Here, a connection destination C1 indicated by the DNN_1 is a Gi-LAN #1, whereas a connection destination C2 indicated by the DNN_2 is a Gi-LAN #2, which indicate different connection destinations.

As illustrated in FIG. 3, the AUSF/UDM 21 has a receiving unit 111, a determining unit 112, and a transmitting unit 113. The receiving unit 111 receives from the AMF 20 an inquiry for the subscriber information of the user equipment T1 and, in relation therewith, the identification information of the user equipment T1, and information about the DNN_1 and the TA.

The determining unit 112 acquires the connection destination information of the user equipment T1 associated with the TA in response to the inquiry received by receiving unit 111. Specifically, using the identification information of the user equipment T1 as a key, the determining unit 112 searches and refers to the data network information (1) about the connection destination associated with the user equipment T1 from the subscriber information held in the DB 210. Then, since the TA is “xyz0000”, DNN_2 (bbb.co.jp; second connection destination information) shown in (1) is acquired. Then, it is determined that the acquired DNN_2 is different from the DNN_1 transmitted by the user equipment T1. In a case where the determining unit 112 determines that the DNN_2 is different from the DNN_1, the transmitting unit 113 transmits subscriber information including the DNN_2 to the AMF 20 as an Ack response of communication.

The receiving unit 101 of the AMF 20 receives the Ack response (subscriber information) of communication from the AUSF/UDM 21. The connection control unit 103 sets, as the connection destination of the user equipment T1, the DNN_2 included in the subscriber information received by the receiving unit 101 instead of the DNN_1 received from the user equipment T1 first. Then, by causing the transmitting unit 102 to transmit the DNN_2 to the SMF 22, the connection control unit 103 controls the user equipment T1 to connect to the DNN_2.

The SMF 22 executes session management such as session establishment/disconnection for each network slice. In response to receiving the DNN_2 from the AMF 20, the SMF 22 executes session establishment processing with respect to the received DNN_2. The details of this connection processing will be described later.

As described above, the user equipment T1 can connect to the Gi-LAN #2, which is the connection destination indicated by the DNN_2. In a case where the TA transmitted by the user equipment T1 is other than “xyz0000”, the determining unit 112 of the AUSF/UDM 21 acquires the DNN_1 in response to the inquiry received by the receiving unit 111. In this case, the determining unit 112 determines that the acquired DNN_1 is the same as the DNN_1 transmitted by the user equipment T1. Then, the transmitting unit 113 transmits subscriber information that does not include the DNN information to the AMF 20 as an Ack response of communication. The AMF 20 controls the user equipment T1 to connect to the DNN_1 by transmitting the DNN_1 to the SMF 22 based on the subscriber information. Therefore, the AMF 20 and the AUSF/UDM 21 in the communication system S3 can work together to connect the user equipment T1 to the suitable data network indicated by the position information TA. In other words, the communication system S3 can automatically convert the connection destination of the user equipment T1. In addition, since the processing executed by the AMF 20, the AUSF/UDM 21 and the SMF 22 is the same as that of the known 5G technology, the explanation is omitted.

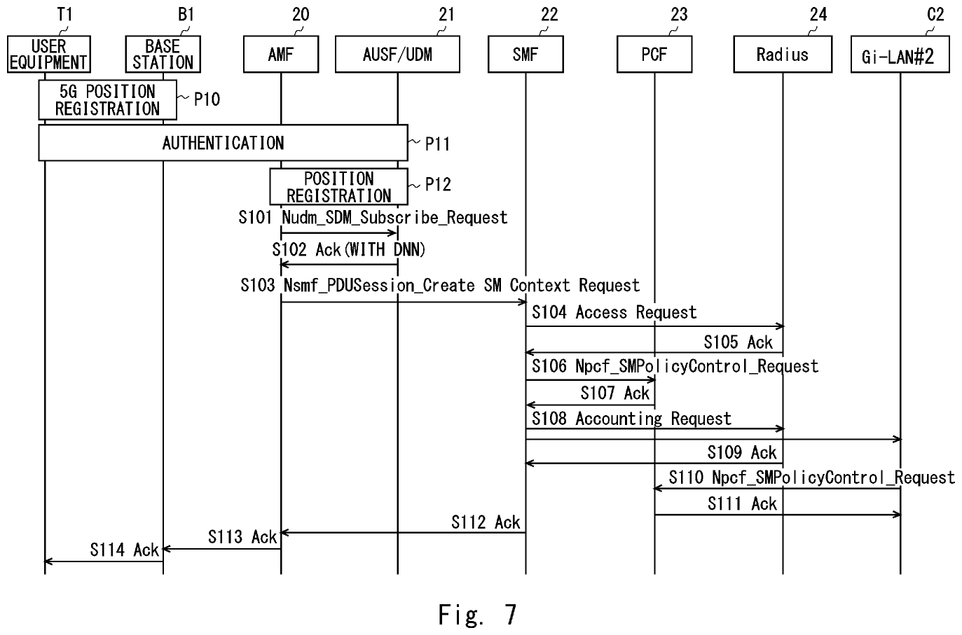

FIG. 7 is a sequence diagram illustrating an example of processing of the communication system S3. Hereinafter, the processing performed when the user equipment T1 starts communication will be described below using FIG. 7. Note that a base station B1 is an element that constitutes a RAN (Radio Access Network), and connects the user equipment T1 and the C-plane side. A PCF (Policy Control Function) 23 is a node that executes processing related to network policy, for example, control of data communication with the Gi-LAN #2. A Radius (Remote Authentication Dial In User Service) 24 is a node related to the authentication protocol, and when the SMF 22, which is the client, transmits an access request packet, the Radius 24, which is the server, responds one of Access Granted, Access Denied, or Access Challenge (which re-requests password entry). First, sequence processing, which is a premise, will be explained. When the user of the user equipment T1 inserts a SIM (Subscriber Identity Module) card into the user equipment T1 and operates the user equipment T1 to start communication processing, the user equipment T1 connects to the base station B1, and the user equipment T1 and the base station B1 perform position registration processing P10 of 5G. Next, a connection request from the user equipment T1 to the core network is transmitted to the AMF 20, and the AMF 20 and the AUSF/UDM 21 execute authentication processing P11. In response, the AMF 20 and the AUSF/UDM 21 perform position registration processing P12. Here, the DNN_1, which is connection destination information recorded in the SIM card, is also included in the connection request to the core network transmitted by the user equipment T1.

Then, the AMF 20 transmits Nudm_SDM_Subscribe_Request to the AUSF/UDM 21 as an inquiry for the subscriber information of the user equipment T1 (step S101). The AMF 20 also transmits the identification information of the user equipment T1, the DNN_1, which is the connection destination information, and the TA (xyz0000), which is the position information, to the AUSF/UDM 21. As explained above, this DNN_1 is the connection destination information recorded in the SIM card.

The determining unit 112 of the AUSF/UDM 21 executes the above processing and acquires the DNN_2 based on the TA being “xyz0000”. Then, the transmitting unit 113 transmits subscriber information including the DNN_2 to the AMF 20 as an Ack response of communication (step S102).

The connection control unit 103 of the AMF 20 sets the received DNN_2 as the connection destination of the user equipment T1. The transmitting unit 102 transmits, as a session start request, NsmfPDUSession_Create SM Context Request including information about the DNN_2 to the SMF 22 (step S103).

The SMF 22 that has received the session start request transmits an Access Request to the Radius 24 (step S104). In response, the Radius 24 responds an Ack of access permission to the SMF 22 (step S105).

Also, the SMF 22 transmits Npcf_SMPolicyControl_Request to the PCF 23 when starting data communication with the Gi-LAN #2 indicated by the DNN_2 (step S106). In response, the PCF 23 transmits an Ack indicating permission to the SMF 22 (step S107).

Based on the Ack received from the PCF 23, the SMF 22 determines that an event of accounting has occurred, and transmits an Accounting Request to the Radius 24 and the Gi-LAN #2 (step S108). Here, the SMF 22 can perform connection processing to the Gi-LAN #2, which is an appropriate connection destination, based on the connection destination information of the user equipment T1 converted in the processing of steps S101 and S102. In response, the Radius 24 responds an Ack indicating that accounting is possible to the SMF 22 (step S109).

The Gi-LAN #2 that has received the Accounting Request transmits Npcf_SMPolicyControl_Request to the PCF 23 at the start of data communication with the user equipment T1 (step S110). In response, the PCF 23 responds an Ack indicating permission to the Gi-LAN #2 (step S111).

In response to the response Ack from the Radius 24, the SMF 22 transmits an Ack indicating that a session with the Gi-LAN #2 has started to the AMF 20 (step S112). In response, the AMF 20 transmits an Ack to the base station B1 (step S113). In response, the base station B1 transmits an Ack to user equipment T1 (step S114). As described above, data communication between the user equipment T1 and the Gi-LAN #2 starts.

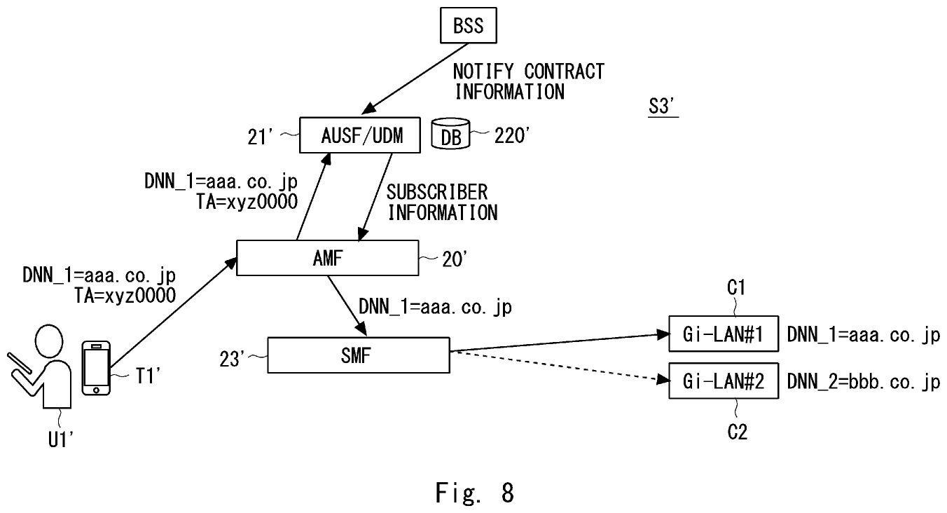

FIG. 8 is a schematic diagram illustrating an example of a 5G communication system according to related art. A communication system S3′ includes, as main constituent elements, an AMF 20′, an AUSF/UDM 21′ and a SMF 22′. The AMF 20′, the AUSF/UDM 21′, and the SMF 2T have functions similar to the AMF 20, the AUSF/UDM 21, and the SMF 22, respectively. However, the AUSF/UDM 21′ has a function of responding subscriber information in response to an inquiry for subscriber information of the user equipment T1 received from the AMF 20, but does not have a function of acquiring connection destination information of the user equipment T1′ associated with the TA and transmitting it to the AMF 20′. Therefore, the AMF 20′ directly uses the information of the DNN_1 received from the user equipment T1′ to connect the user equipment T1′ to the Gi-LAN #1 indicated by the DNN_1. However, there is a problem in that, even if the position information indicated by the TA is “xyz0000”, the user equipment T1′ connects to the Gi-LAN #1 instead of the Gi-LAN #2, which is preferable as the connection destination. In order to connect the user equipment T1 to the Gi-LAN #2, a user U1′ has to operate the user equipment T1′ to switch the connection destination.

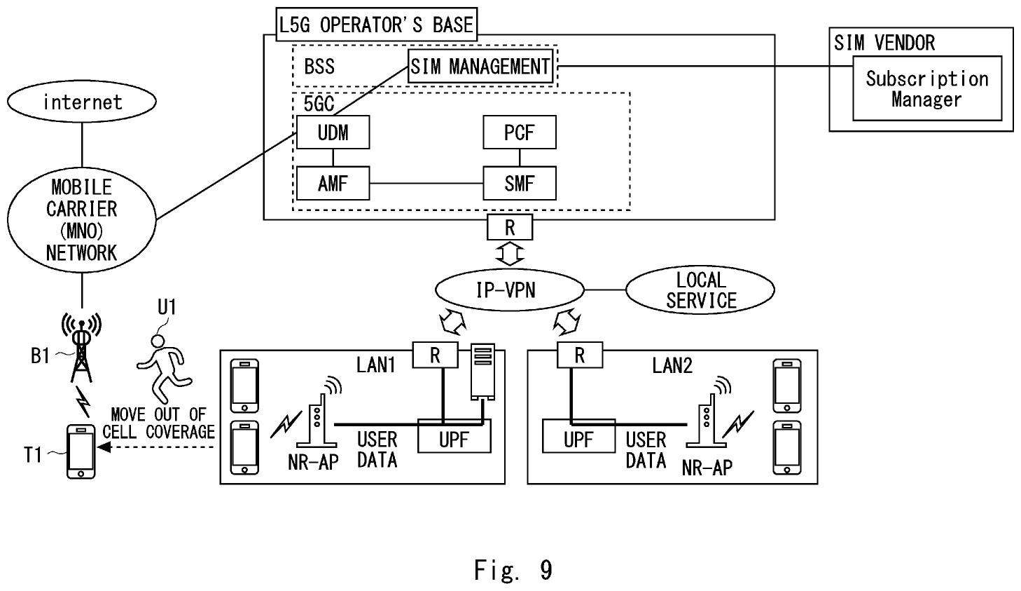

FIG. 9 is a schematic diagram illustrating an example of an application situation of the 5G communication system. FIG. 9 illustrates a state in which the user U1, who owns the user equipment T1, moves from the premises of a LAN (Local Area Network) 1 to a public network outside its range. The LANs 1 and 2 are predetermined closed networks, and the user equipment connects to the outside by wireless communication R via a NR-AP (New Radio-Access Point) and a UPF (User Plane Function) in the premises. Also, the LANs 1 and 2 are connected to each other by a closed IP (Internet Protocol) network based on IP-VPN (Virtual Private Network). The user equipment can be connected to 5GC (5th Generation Core network) described later, and can be connected to any local service via IP-VPN. However, instead of IP-VPN, the LANs 1 and 2 may be connected to each other by a wide area wired network.

On the other hand, when the user U1 is in a public network, the user equipment T1 connects to a mobile network operator (MNO) network via the base station B1, and can be connected to the Internet via the MNO network. Also, the user equipment T1 can connect with 5GC by roaming through the MNO network.

The 5GC is a mobile core network system that accommodates 5G radio, and is deployed in a L5G (Local 5G) operator's bases along with SIM management nodes. The 5GC has a UDM, an AMF, a SMF and a PCF, and the functions of these nodes are described above. The SIM management node is provided in the above-described BSS, and when the SIM management node acquires information about the SIM card from a Subscription Manager owned by a SIM vendor other than the L5G operator, the SIM management node transmits the information to the UDM as the above-described contract information. The UDM stores the information into the DB as subscriber information. In addition to the BSS, the SIM management node may be configured as part of the functions of OSS (Operation Support Systems) that support network operation.

When the user U1 is in the premises of LAN 1, the user equipment T1 connects to the 5GC via the IP-VPN, and from there, the user equipment T1 connects the connection destination C1 indicated by the connection destination information DNN_1 stored in the SIM possessed by the user equipment T1. This connection destination C1 is a data network that can be used by the user equipment T1 without any problem if the user equipment T1 is in the premises of the LAN 1.

However, when the user U1 leaves the LAN 1 and is in a public network, the user equipment T1 connects to the 5GC through the base station B1. The connection destination C2 may provide a service for mobile communication, whereas the connection destination C1 may not provide a service for mobile communication. In such a case, the preferred connection destination for communication for the user equipment T1 is the connection destination C2.

Also, according to the contract between the user U1 and the communication carrier, the Gi-LAN #2 indicated by the connection destination C2 provides services related to the amount of communication, such as count-free or video compression, whereas the Gi-LAN #1 indicated by the connection destination C1 may not provide such a service. When the user equipment T1 is in the premises of the LAN 1, even if the user equipment T1 communicates via the 5GC, the amount of communication is not counted as the amount of communication under the contract of the user U1 with the communication carrier. Therefore, no problem occurs even if the user equipment T1 connects to the connection destination C1 when the above services are not used. However, when the user equipment T1 is on the public network, the communication amount of data communicated via the public network is counted in the communication amount under the contract. Therefore, it is preferable that the user equipment T1 connects to the connection destination C2 through which the above services can be received.

In the above cases, the 5GC allows the user equipment T1 to connect automatically to the connection destination C2 instead of the connection destination C1 when the user equipment T1 is on the public network by executing the processing illustrated in FIGS. 7 and 8. This saves the user U1 the trouble of operating the user equipment T1 to switch the connection destinations.

(4G)

Next, an example of application of the first example embodiment to the 4G communication standard is shown. In the following explanation, the explanation of the part explained in (5G) will be omitted as appropriate.

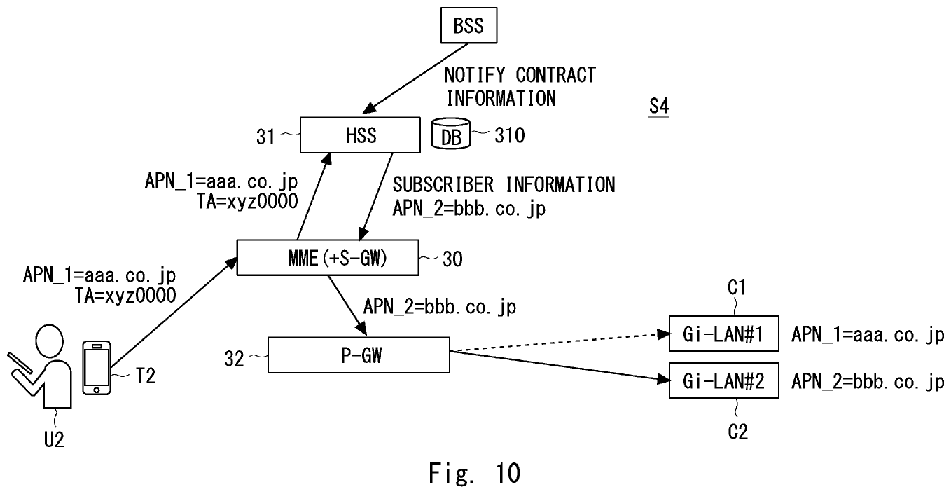

FIG. 10 is a schematic diagram illustrating an example of a 4G communication system. A communication system S4 includes, as main constituent elements, an MME (Mobility Management Entity) 30, a HSS (Home Subscriber server 31, and a P-GW (Packet data network Gateway) 32. The MME 30, the HSS 31, and the P-GW 32 are nodes which belong to the C-plane function side. Hereinafter, processing of each apparatus will be explained.

The MME 30 corresponds to the control apparatus 10 according to the first example embodiment, and executes processing similar to the AMF 20. Specifically, as illustrated in FIG. 2, the MME 30 includes a receiving unit 101, a transmitting unit 102, and a connection control unit 103. The receiving unit 101 receives a connection request to the network from the user equipment T2 owned by the user U2. This connection request includes at least an APN_1 (aaa.co.jp; first connection destination information), which is the connection destination information of the user equipment T2, and a TA, which is information about the position registration area of the base station that accommodates the user equipment T2. Furthermore, the connection request also includes the identification information of the user equipment T2. In response to this connection request, the transmitting unit 102 not only transmits an inquiry about subscriber information of the user equipment T2 to the HSS 31, but also transmits the identification information of the user equipment T2, the APN_1, and the TA to the HSS 31. The details of the connection control unit 103 will be described later.

The HSS 31 corresponds to the communication management server 11 according to the first example embodiment, and executes processing similar to the AUSF/UDM 21. The HSS 31 includes a DB 310 as a repository that holds and manages subscriber information, and executes communication processing of the user equipment based on the subscriber information held in the DB 310. Also, the HSS 31 acquires subscriber information for each subscriber from the BSS and stores the subscriber information into the DB 310.

With respect to the user equipment T2, the following subscriber information is held in the DB 310.
TA is other than “xyz0000”: APN_1 (aaa.co.jp)
TA is “xyz0000”: APN_2 (bbb.co.jp) . . . (2)

Here, a connection destination C1 indicated by the APN_1 is Gi-LAN #1, whereas a connection destination C2 indicated by the APN_2 is Gi-LAN #2, which indicate different connection destinations.

As illustrated in FIG. 3, the HSS 31 includes a receiving unit 111, a determining unit 112, and a transmitting unit 113. The receiving unit 111 receives from the MME 30 an inquiry for the subscriber information of the user equipment T2 and, in relation therewith, the identification information of the user equipment T2, and information about the APN_1 and the TA.

The determining unit 112 acquires the connection destination information of the user equipment T2 associated with the TA in response to the inquiry received by receiving unit 111. At this time, since the TA is “xyz0000”, the determining unit 112 acquires the APN_2 (bbb.co.jp; second connection destination information) shown in (2). Then, it is determined that the acquired APN_2 is different from the APN_1 transmitted by the user equipment T2. In a case where the determining unit 112 determines that the APN_2 is different from the APN_1, the transmitting unit 113 transmits subscriber information including the APN_2 to the AMF 20 as an Ack response of communication.

The receiving unit 101 of the MME 30 receives the Ack response (subscriber information) of communication from the HSS 31. The connection control unit 103 sets, as the connection destination of the user equipment T2, the APN_2 included in the subscriber information received by the receiving unit 101 instead of the APN_1 received from the user equipment T2 first. Then, the connection control unit 103 controls a S-GW (Serving Gateway) explained later to transmit the APN_2 to the P-GW 32, so that the user equipment T2 connects to the APN_2.

The P-GW 32 is a gateway for connection to an external network, and in response to receiving the APN_2 from the S-GW, executes session establishment processing with respect to the received APN_2. The details of this connection processing will be described later.

As described above, the user equipment T2 can connect to the Gi-LAN #2, which is the connection destination indicated by the APN_2. In a case where the TA transmitted by the user equipment T2 is other than “xyz0000”, the determining unit 112 of the HSS 31 acquires the APN_1 in response to the inquiry received by the receiving unit 111. In this case, the determining unit 112 determines that the acquired APN_1 is the same as the APN_1 transmitted by the user equipment T2. Then, the transmitting unit 113 transmits subscriber information that does not include APN information to the MME 30 as an Ack response of communication. Based on the subscriber information, the S-GW transmits the APN_1 to the P-GW 32, thereby controlling the user equipment T2 to connect to the APN_1. Therefore, the MME 30 and the HSS 31 in the communication system S4 can work together to connect the user equipment T2 to the suitable data network indicated by the position information TA. In other words, the communication system S4 can automatically convert the connection destination of the user equipment T2. In addition, since other processing executed by the MME 30, the HSS 31, and the P-GW 32 is the same as that of the known 4G technology, the explanation is omitted.

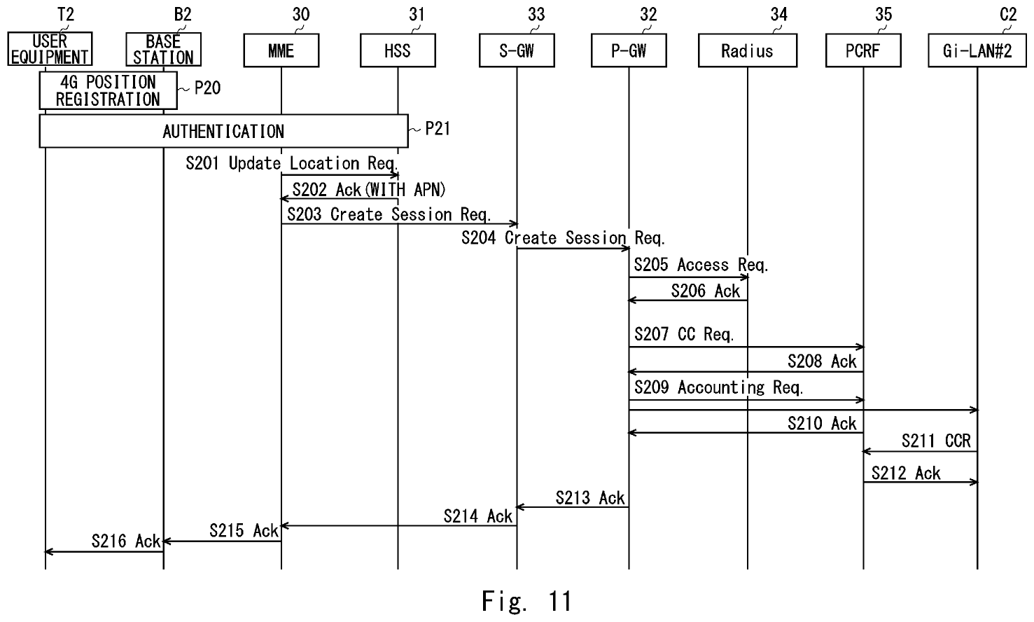

FIG. 11 is a sequence diagram illustrating an example of processing of the communication system S4. Hereinafter, the processing performed when the user equipment T2 starts communication will be described with reference to FIG. 11. The S-GW 33 is a position registration packet gateway for data transmission, and is a node that sets and releases communication routes, in units of external packet networks, with the P-GW 32. A PCRF (Policy and Charging Rule Function) 35 is a node that sets policies such as priority control and charging method according to the communication service. Also, in FIG. 11, a Request is abbreviated as Req.

First, the prerequisite sequence processing will be explained. When the user of the user equipment T2 inserts the SIM card into the user equipment T2 and operates the user equipment T2 to start communication processing, the user equipment T2 connects to the base station B2, and the user equipment T2 and the base station B2 execute 4G position registration processing P20. Next, a connection request from the user equipment T2 to the core network is transmitted to the MME 30, and the MME 30 and the HSS 31 execute authentication processing P21. Here, the connection request to the core network transmitted by the user equipment T2 also includes the APN_1, which is the connection destination information recorded in the SIM card.

After the authentication process P21, the MME 30 transmits an Update Location Req. to the HSS 31 as an inquiry for the subscriber information of the user equipment T2 (step S201). The MME 30 transmits, to the HSS 31, the identification information of the user equipment T2, the APN_1 which is the connection destination information, and the TA which is the position information. As described above, this APN_1 is the connection destination information recorded in the SIM card.

The determining unit 112 of the HSS 31 performs the above process and acquires the APN_2 based on the TA being “xyz0000”. Then, the transmitting unit 113 transmits the subscriber information including the APN_2 to the AMF 20 as an Ack response of communication (step S202).

The connection control unit 103 of the MME 30 sets the received APN_2 as the connection destination of the user equipment T2. The transmitting unit 102 transmits a Create Session Req., which is a session start request including information about the APN_2, to the S-GW33 (step S203). The S-GW33 transmits the Create Session Req. to the P-GW 32 (step S204).

The P-GW 32 that has received the session start request transmits an Access Req. to the Radius 34 (step S205). In response, the Radius 34 responds an Ack of access permission to the P-GW 32 (step S206).

Also, the P-GW 32 transmits a CC (Component Carrier) Req. to the PCRF (step S207). In response, the PCRF 35 responds an Ack indicating permission to the P-GW 32 (step S208).

The P-GW 32 determines that an event of accounting has occurred based on the Ack received from the PCRF 35, and transmits an Accounting Req. to the PCRF 35 and the Gi-LAN #2 (step S209). Here, the P-GW 32 can perform connection processing of the Gi-LAN #2, which is an appropriate connection destination, based on the connection destination information of the user equipment T2 converted in steps S201 and S202. In response, the PCRF 35 responds an Ack indicating that accounting is possible to the SMF 22 (step S210).

The Gi-LAN #2, which has received the Accounting Req., transmits a CCR (Credit Control Request) to the PCRF 35 at the start of data communication with the user equipment T2 (step S211). In response, the PCRF 35 replies an Ack indicating permission to the Gi-LAN #2 (step S212).

In response to the response Ack from the PCRF 35, the P-GW 32 transmits an Ack indicating that a session with the Gi-LAN #2 has started to the S-GW 33 (step S213). In response, the S-GW33 transmits an Ack to the MME 30 (step S214). The MME 30 transmits an Ack to the base station B2 (step S215). In response, the base station B2 transmits an Ack to the user equipment T2 (step S216). As described above, data communication between the user equipment T2 and the Gi-LAN #2 is started.

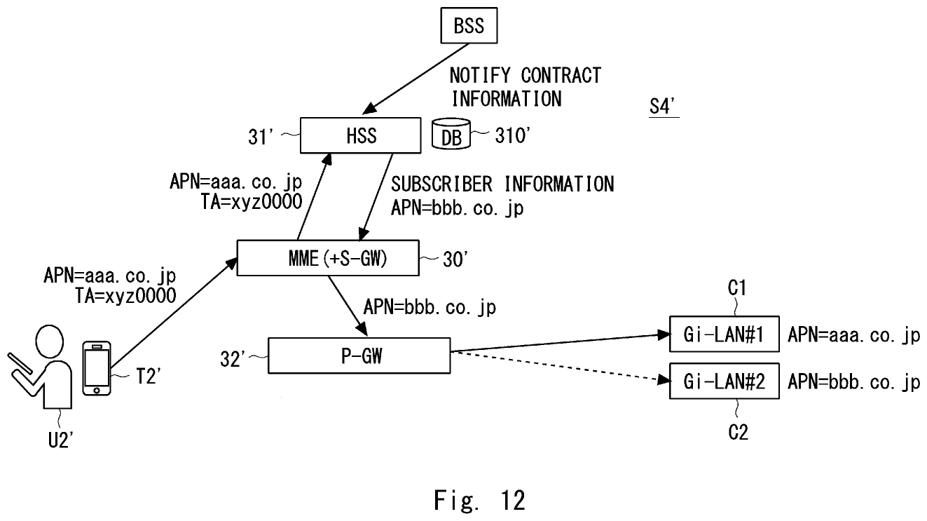

FIG. 12 is a schematic diagram illustrating an example of a 5G communication system according to related art. The communication system S4′ includes, as main constituent elements, an MME 30′, a HSS 31′, and a P-GW 32′. The MME 30′, the HSS 31′, and the P-GW 3T have functions similar to the MME 30, the HSS 31, and the P-GW 32, respectively. However, the HSS 31′ has a function of responding subscriber information in response to an inquiry for subscriber information of the user equipment TT received from the MME 30′, but does not have a function of acquiring connection destination information about the user equipment TT associated with the TA and transmitting it to the MME 30′. Therefore, the MME 30′ directly uses the information of the APN_1 received from the user equipment TT to connect the user equipment TT to the Gi-LAN #1 indicated by the APN_1. However, there is a problem in that, even if the position information indicated by the TA is “xyz0000”, the user equipment TT connects to the Gi-LAN #1 instead of the Gi-LAN #2, which is preferable as the connection destination. In order to connect the user equipment TT to the Gi-LAN #2, a user UT has to operate the user equipment T1 to switch the connection destination.

As described above, in the second example embodiment, in specific standards such as 5G and 4G, when the user equipment connects to the network, the user does not need to switch the connection destination of the user equipment.

In mobile services, using the DNN or the APN, which are multiple connection destinations, to connect the user equipment to various services has the advantage of increasing the value of services provided to users. It can be said that there are also advantages for communication carriers who can differentiate themselves from other companies by making it possible to provide a variety of services. However, it is troublesome for the user to operate the user equipment and specify the DNN or the APN of the connection destination. Therefore, in order to be able to provide a variety of services according to the user's contract and position information (position registration information), it is meaningful to implement this processing on the network side. Specifically, the UDM or the HSS transmits subscriber information to an appropriate connection destination according to the user's contract and position information, and the AMF or MME can control the connection to that connection destination.

For example, a case may be assumed in which a user who does not have much knowledge about the DNN or the APN can use the same user equipment (especially, one with the same SIM card) to switch between multiple communication services (for example, one with video compression service and one without video compression service) to use them. At that time, the communication carrier does not need to explain to such a user how to switch the connection destination, so the support cost on the communication carrier side can be reduced. In addition, when the user switches between multiple communication services for the user equipment of many IoT (Internet of Things) devices, the user can save the trouble of manually setting the DNN or the APN for many devices. This can reduce operating costs for IoT device owners.

In a case where the TA is the first position information, the AMF 20 or the MME 30 (communication management server) acquires the DNN_1 or the APN_1 (third connection destination information) associated with the first position information. On the other hand, in a case where the TA is the second position information, the AMF 20 or the MME 30 (communication management server) acquire the DNN_2 or the APN_2 (fourth connection destination information) associated with that second position information. With this configuration, the AMF 20 or the MME 30 can be connected to an appropriate connection destination according to the position information of the user equipment T1.

Here, the first position information may indicate that the user equipment belongs to a predetermined closed network (for example, Local 5G), and the second position information may indicate that the user equipment belongs to a public network. As a result, even if the user operates his or her own user equipment with only one SIM card, the network side can cause the user equipment to connect to an appropriate connection destination according to the position registration information of the user equipment.

Also, the first communication service provided to the user equipment by the network indicated by the DNN_1 or the APN_1 and the second communication service provided to the user equipment by the network indicated by the DNN_2 or the APN_2 may be different communication services. This allows the user to receive different communication services depending on the user equipment when the user is in different locations. For example, different communication services can be received depending on whether the user equipment is connected to the Local 5G network via LAN or the user equipment is connected to the Local 5G network via a public network. Examples of different communication services include the presence or absence of specific services of the Gi-LAN (for example, services such as count-free and video compression).

On the network side, the TA can be used as the position information for switching the connection destination of the user equipment. As a result, on the network side, the configuration related to the related art can be easily diverted to execute the processing of the present disclosure.

The present disclosure is also applicable to 5G and 4G standards. However, the present disclosure is applicable not only to standards such as 5G and 4G, but also to communication networks in which similar processing is executed for communication.

Note that the present invention is not limited to the above embodiments, and can be modified as appropriate without departing from the scope of the invention. Furthermore, the arrows illustrated in each schematic diagram referenced in the first and second example embodiments exemplify the data flow described in the specification, and two-way communication of other data can be performed between multiple apparatus illustrated in each schematic diagram.

In the embodiments explained above, this disclosure has been described as a hardware configuration, but this disclosure is not limited thereto. This disclosure can also implement the processes (steps) of the apparatuses explained in the above-described embodiments (for example, the control apparatus, the communication management server, and the apparatuses corresponding to those apparatuses in 5G and 4G) by causing a processor in a computer to execute a computer program.

FIG. 19 is a block diagram illustrating a hardware configuration example of an information processing apparatus (signal processing apparatus) in which the processing of each embodiment described above is executed. Referring to FIG. 19, this information processing apparatus 90 includes a signal processing circuit 91, a processor 92, and a memory 93.

A signal processing circuit 91 is a circuit for processing a signal according to the control of the processor 92. The signal processing circuit 91 may also include a communication circuit for receiving signals from a transmission apparatus.

The processor 92 reads out software (computer programs) from the memory 93 and executes the software to perform the processing of the apparatuses described in the above embodiments. As an example of the processor 92, any one of a CPU (Central Processing Unit), a MPU (Micro Processing Unit), a FPGA (Field-Programmable Gate Array), a DSP (Demand-Side Platform), and an ASIC (Application Specific Integrated Circuit) may be used, or two or more thereof may be used in parallel.

The memory 93 is constituted by a volatile memory, a non-volatile memory, or a combination thereof. The number of memories 93 is not limited to one, and multiple memories 93 may be provided. For example, the volatile memory may be a RAM (Random Access Memory) such as a DRAM (Dynamic Random Access Memory) and a SRAM (Static Random Access Memory). The non-volatile memory may be, for example, a ROM (Random Only Memory) such as a PROM (Programmable Random Only Memory) and an EPROM (Erasable Programmable Read Only Memory), or an SSD (Solid State Drive).

The memory 93 is used to store one or more instructions. Here, one or more instructions are stored in the memory 93 as a software module group. The processor 92 can perform the processing described in the above embodiments by reading and executing these software module groups from the memory 93.

Note that, in addition to the memory 93 provided outside the processor 92, the memory 93 built into the processor 92 may be included. The memory 93 may also include a storage located remotely from the processor constituting the processor 92. In this case, the processor 92 can access the memory 93 via an I/O (Input/Output) interface.

As explained above, one or more processors possessed by each apparatus according to the above-described embodiments execute one or more programs containing instruction groups for causing the computer to execute the algorithms explained with reference to the drawings. According to this processing, the signal processing method described in each embodiment can be realized.

Programs can be stored and delivered to computers using various types of non-transitory computer-readable media. The non-transitory computer-readable media include various types of tangible storage media. Examples of non-transitory computer-readable media include a magnetic recording medium (for example, a flexible disk, a magnetic tape, and a hard disk drive), a magneto-optical recording medium (for example, a magneto-optical disk), a CD-ROM (Read Only Memory), a CD-R, a CD-R/W, a semiconductor memory (for example, a mask ROM, a PROM (Programmable ROM), an EPROM (Erasable PROM), a flash ROM, a RAM (Random Access Memory)). The programs may also be delivered to the computer on various types of transitory computer-readable media. Examples of temporary computer-readable media include electrical signals, optical signals, and electromagnetic waves. A temporary computer-readable medium can supply programs to a computer via a wired communication path such as wires and optical fibers, or a wireless communication path.

Some or all of the above embodiments can also be described in the following Supplementary Note, but are not limited thereto.

(Supplementary Note 1)

A communication system including:
a control apparatus configured to control connection of user equipment; and
a communication management server connected to the control apparatus, wherein,
in response to receiving a connection request from the user equipment to a first connection destination, the control apparatus transmits position information of the user equipment to the communication management server,
the communication management server acquires second connection destination information indicating a second connection destination of the user equipment associated with the position information, and transmits the acquired second connection destination information to the control apparatus, and
the control apparatus sets the second connection destination indicated by the second connection destination information as a connection destination of the user equipment with precedence over the first connection destination, and controls the user equipment in such a way as to connect to the connection destination.

(Supplementary Note 2)

The communication system according to Supplementary Note 1, wherein in a case where the position information is first position information, the communication management server acquires third connection destination information associated with the first position information as the second connection destination information, and in a case where the position information is second position information, the communication management server acquires fourth connection destination information associated with the second position information as the second connection destination information, and transmits the acquired second connection destination information to the control apparatus.

(Supplementary Note 3)

The communication system according to Supplementary Note 2, wherein the first position information indicates that the user equipment belongs to a predetermined closed network, and the second position information indicates that the user equipment belongs to a public network.

(Supplementary Note 4)

The communication system according to Supplementary Note 2 or 3, wherein a first communication service to be provided to the user equipment by a network indicated by the third connection destination information and a second communication service to be provided to the user equipment by a network indicated by the fourth connection destination information are different communication services.

(Supplementary Note 5)

The communication system according to any one of Supplementary Notes 1 to 4, wherein the position information is information about a position registration area of a base station that accommodates the user equipment.

(Supplementary Note 6)

The communication system according to any one of Supplementary Notes 1 to 5, wherein the control apparatus is an apparatus according to Access and Mobility Management Function (AMF) of 5th Generation (5G) standard, and the communication management server is a server according to Unified Data Management (UDM) of 5G standard.

(Supplementary Note 7)

A communication management server including:
a receiving means for receiving first connection destination information being information about a first connection destination to which user equipment requests connection, and position information of the user equipment, from a control apparatus configured to control connection of the user equipment;
a determining means for acquiring second connection destination information being information about a connection destination of the user equipment associated with the position information, and determining whether the second connection destination information is different from the first connection destination information; and
a transmitting means for transmitting the second connection destination information to the control apparatus in a case where the second connection destination information is different from the first connection destination information.

(Supplementary Note 8)

The communication management server according to Supplementary Note 7, wherein in a case where the position information is first position information, the determining means acquires third connection destination information associated with the first position information as the second connection destination information, and in a case where the position information is second position information, the determining means acquires fourth connection destination information associated with the second position information as the second connection destination information.

(Supplementary Note 9)

A control apparatus comprising:
a receiving unit configured to receive a connection request from user equipment to a first connection destination;
a transmitting unit configured to, in response to the connection request, transmit position information of the user equipment to a communication management server; and
a connection control unit configured to set a second connection destination indicated by second connection destination information received from the communication management server as a connection destination of the user equipment with precedence over the first connection destination, and control the user equipment in such a way as to connect to the connection destination.

(Supplementary Note 10)

The control apparatus according to Supplementary Note 9, wherein the control apparatus is an apparatus according to Access and Mobility Management Function (AMF) of 5th Generation (5G) standard.

(Supplementary Note 11)

A communication management method to be executed by a communication system, the method including:
transmitting, by a control apparatus controlling connection of user equipment, in response to receiving a connection request from the user equipment to a first connection destination, position information of the user equipment to a communication management server;
acquiring, by the communication management server, second connection destination information indicating a second connection destination of the user equipment associated with the position information, and transmitting the acquired second connection destination information to the control apparatus; and
setting, by the control apparatus, the second connection destination indicated by the second connection destination information as a connection destination of the user equipment with precedence over the first connection destination, and controlling the user equipment in such a way as to connect to the connection destination.

(Supplementary Note 12)

A communication management method to be executed by a communication management server, the method including:
receiving first connection destination information being information about a first connection destination to which user equipment requests connection, and position information of the user equipment, from a control apparatus configured to control connection of the user equipment;
acquiring second connection destination information being information about a connection destination of the user equipment associated with the position information, and determining whether the second connection destination information is different from the first connection destination information; and
transmitting the second connection destination information to the control apparatus in a case where the second connection destination information is different from the first connection destination information.

(Supplementary Note 13)

A communication control method to be executed by a control apparatus, the method including:
receiving a connection request from user equipment to a first connection destination;
in response to the connection request, transmitting position information of the user equipment to a communication management server; and
setting a second connection destination indicated by second connection destination information received from the communication management server as a connection destination of the user equipment with precedence over the first connection destination, and controlling the user equipment in such a way as to connect to the connection destination.

(Supplementary Note 14)

A non-transitory computer-readable medium storing a program that causes a computer to execute:
receiving first connection destination information being information about a first connection destination to which user equipment requests connection, and position information of the user equipment, from a control apparatus configured to control connection of the user equipment;
acquiring second connection destination information being information about a connection destination of the user equipment associated with the position information, and determining whether the second connection destination information is different from the first connection destination information; and
transmitting the second connection destination information to the control apparatus in a case where the second connection destination information is different from the first connection destination information.

(Supplementary Note 15)

A non-transitory computer-readable medium storing a program that causes a computer to execute:
receiving a connection request from user equipment to a first connection destination;
in response to the connection request, transmitting position information of the user equipment to a communication management server; and
setting a second connection destination indicated by second connection destination information received from the communication management server as a connection destination of the user equipment with precedence over the first connection destination, and controlling the user equipment in such a way as to connect to the connection destination.

Although the present invention has been described with reference to the embodiments, the present invention is not limited thereto. Various changes can be made to the configuration and details of the present invention within the scope of the invention that a person skilled in the art can understand.

### REFERENCE SIGNS LIST

S1 to S2 COMMUNICATION SYSTEM
10 CONTROL APPARATUS
101 RECEIVING UNIT
102 TRANSMITTING UNIT
103 CONNECTION CONTROL UNIT
11 COMMUNICATION MANAGEMENT SERVER
111 RECEIVING UNIT
112 DETERMINING UNIT
113 TRANSMITTING UNIT
20 AMF
21 AUSF/UDM
22 SMF
30 MME
31 HSS
32 P-GW

What is claimed is:

1.-6. (canceled)

7. A communication management server comprising:
at least one memory storing instructions; and
at least one processor configured to execute the instructions to:
receive first connection destination information being information about a first connection destination to which user equipment requests connection, and position information of the user equipment, from a control apparatus configured to control connection of the user equipment;
acquire second connection destination information being information about a connection destination of the user equipment associated with the position information;
determine whether the second connection destination information is different from the first connection destination information; and
transmit the second connection destination information to the control apparatus in a case where the second connection destination information is different from the first connection destination information.

8. The communication management server according to claim 7, wherein, the at least one processor is further configured to, in a case where the position information is first position information, acquire third connection destination information associated with the first position information as the second connection destination information, and in a case where the position information is second position information, acquire fourth connection destination information associated with the second position information as the second connection destination information.

9. A control apparatus comprising:
at least one memory storing instructions; and
at least one processor configured to execute the instructions to:
receive a connection request from user equipment to a first connection destination;
in response to the connection request, transmit position information of the user equipment to a communication management server; and
set a second connection destination indicated by second connection destination information received from the communication management server as a connection destination of the user equipment with precedence over the first connection destination, and control the user equipment in such a way as to connect to the connection destination.

10. The control apparatus according to claim 9, wherein the control apparatus is an apparatus according to Access and Mobility Management Function (AMF) of 5th Generation (5G) standard.

11. (canceled)

12. A communication management method to be executed by a communication management server, the method comprising:
receiving first connection destination information being information about a first connection destination to which user equipment requests connection, and position information of the user equipment, from a control apparatus configured to control connection of the user equipment;
acquiring second connection destination information being information about a connection destination of the user equipment associated with the position information, and determining whether the second connection destination information is different from the first connection destination information; and
transmitting the second connection destination information to the control apparatus in a case where the second connection destination information is different from the first connection destination information.

13.-15. (canceled)

16. The communication management server according to claim 8, wherein the first position information indicates that the user equipment belongs to a predetermined closed network, and the second position information indicates that the user equipment belongs to a public network.

17. The communication management server according to claim 8, wherein a first communication service to be provided to the user equipment by a network indicated by the third connection destination information and a second communication service to be provided to the user equipment by a network indicated by the fourth connection destination information are different communication services.

18. The communication management server according to claim 7, wherein the position information is information about a position registration area of a base station that accommodates the user equipment.

19. The communication management server according to claim 7, wherein the communication management server is a server according to Unified Data Management (UDM) of 5G standard.
